(19) United States
(12) Patent Application Publication
(10) Pub. No.: US 2006/0193365 A1
(43) Pub. Date: Aug. 31, 2006

(54) Spacer for spacing preforms in a furnace and method for spacing preforms in a furnace using same

(75) Inventor: J. Jay Cress, Mishawaka, IN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL

(21) Appl. No.: 11/348,448

(22) Filed: Feb. 7, 2006

Related U.S. Application Data
(60) Provisional application No. 60/656,085, filed on Feb. 25, 2005.

(51) Int. Cl. H05B 7/144

(52) U.S. Cl. 373/102

(57) ABSTRACT

A furnace spacer (10, 20, 30, 40, 50, 60, 70, 80, 90, 100, 150) for spacing a first annular preform (124) from a second annular preform (124), each of the first and second annular preforms (124) having an outer periphery (130) and a width and an inner opening (126) having a periphery (128) and a width, the spacer (10, 20, 30, 40, 50, 60, 70, 80, 90, 100, 150) including a hub (12, 22, 42, 52, 62, 72, 82, 92, 102, 152) having a width less than the inner opening width and a plurality of members (18, 30, 48, 56, 66, 76, 86, 94, 106, 162) projecting from the hub (12, 22, 42, 52, 62, 72, 82, 92, 102, 152). In addition, a stack formed from a plurality of preforms (124) and spacers (10, 20, 30, 40, 50, 60, 70, 80, 90, 100, 150) stacked for treatment in a furnace (120), each preform (124) including a disk having a center opening (126) having a width and having an outer periphery (130) and each spacer (10, 20, 30, 40, 50, 60, 70, 80, 90, 100, 150) comprising a hub (12, 22, 42, 52, 62, 72, 82, 92, 102, 152) having a width less than the center opening width and a plurality of members (18, 30, 48, 56, 66, 76, 86, 94, 106, 162) projecting outwardly from the hub (12, 22, 42, 52, 62, 72, 82, 92, 102, 152), wherein one of the plurality of spacers (10, 20, 30, 40, 50, 60, 70, 80, 90, 100, 150) is provided between adjacent pairs of the plurality of preforms (124). Also a method of stacking the preforms (124) and spacers (10, 20, 30, 40, 50, 60, 70, 80, 90, 100, 150).

### CROSS-REFERENCE TO RELATED APPLICATIONS

The present application claims the benefit of U.S. Provisional Application No. 60/656,085, filed Feb. 25, 2005, the entire contents of which are hereby incorporated by reference.

### FIELD OF THE INVENTION

The present invention is directed to a spacer for separating adjacent annular preforms in a furnace, and, more specifically, toward a spacer having a hub and a plurality of members projecting from the hub for spacing adjacent annular preforms from one another during a chemical vapor deposition (CVD) process in furnace.

### BACKGROUND OF THE INVENTION

During the manufacture of certain carbon composite disks, preforms may be placed in a furnace and subjected to a CVD process to densify the preforms. Normally, CVD processes are carried out on multiple carbon composite preforms that have been arranged in stacks in a CVD furnace. The carbon composite preform discs generally must be spaced from adjacent disks to allow the gasses used in the CVD process to flow around the preforms and contact the preforms over substantial portions thereof. When a plurality of discrete spacers are used in order to allow the free movement of gasses throughout the furnace, the set up of these spacers can be time consuming. Unitary spacers, while easier to position, may interfere to a significant degree with gas flow. It would therefore be desirable to provide a spacer that is easy to use and that does not interfere to a significant degree with the free flow of gas in a CVD furnace.

### SUMMARY OF THE INVENTION

This problem and others are addressed by the present invention, which comprises, in a first aspect, a furnace spacer for spacing a first annular preform from a second annular preform. Each of the first and second annular preforms has an outer periphery and an inner opening. The spacer includes a hub having a width less than the width of the inner opening and a plurality of members projecting from the hub.

Another aspect of the invention is a stack comprising a plurality of preforms and spacers stacked for treatment in a furnace. Each preform comprises a disk having a center opening and an outer periphery, and each spacer comprises a hub having a width less than the center opening width and a plurality of members projecting outwardly from the hub. One of the plurality of spacers is provided between adjacent pairs of the plurality of preforms.

An additional aspect of the invention is a method of spacing a first preform from a second preform in a furnace that involves providing first and second annular preforms each having a center opening having a width and an exterior periphery and placing the first annular preform on a support. A spacer comprising a hub having a width less than the width of the center opening width and a plurality of members projecting outwardly from said hub is also provided. The second annular preform is placed on the spacer, and the first and second annular preforms and spacer are placed in a furnace.

### BRIEF DESCRIPTION OF THE DRAWINGS

These and other aspects of the invention will be better understood after a reading of the detailed description provided below together with the following drawings, wherein:

FIG. 1 is a perspective view of a spacer having a hub and members projecting from the hub according to a first embodiment of the present invention;

FIG. 2 is a top plan view of the spacer of FIG. 1;

FIG. 3 is a side elevational view of the spacer of FIG. 1;

FIG. 4 is a perspective view of a variation of the spacer of FIG. 1 in which the projecting members are detachable from the hub;

FIG. 5 is an exploded perspective view of the spacer of FIG. 4;

FIG. 6 is a top plan view of a spacer according to a second embodiment of the present invention;

FIG. 7 is a top plan view of a spacer according to a third embodiment of the present invention;

FIG. 8 is a top plan view of a spacer according to a fourth embodiment of the present invention;

FIG. 9 is a top plan view of a spacer according to a fifth embodiment of the present invention;

FIG. 10 is a top plan view of a spacer according to a sixth embodiment of the present invention;

FIG. 11 is a top plan view of a spacer according to a seventh embodiment of the present invention;

FIG. 12 is a top plan view of a spacer according to an eighth embodiment of the present invention;

FIG. 13 is a top plan view of a spacer according to a ninth embodiment of the present invention;

FIG. 15 is a side elevational view of the spacer of FIG. 13;

FIG. 16 is a front elevational view of a plurality of preforms and spacers stacked in a furnace;

FIG. 17 is a sectional plan view taken along line XVII-XVII of FIG. 16; and

FIG. 18 is a flow chart illustrating a method for using a spacer according to an embodiment of the present invention.

### DETAILED DESCRIPTION

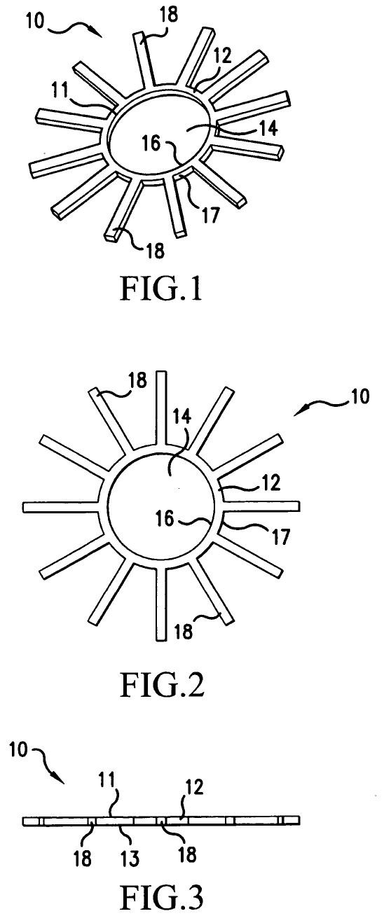

Referring now to the drawings, wherein the showings are for the purpose of illustrating preferred embodiments of the invention only and not for the purpose of limiting same, FIGS. 1-3 show a spacer 10 according to a first embodiment of the invention which comprises a hub 12 having a top 11, a bottom 13, an open center 14 with a periphery 16 and an outer hub periphery 17. A plurality of members or fingers 18 project outwardly from hub 12 with respect to the center of hub 12. The fingers 18 are shown to project radially in these figures, but some or all the fingers may project from hub 12 so that they are not radially disposed. In this embodiment, fingers 18 are integrally formed with hub 12. And, while a total of 12 projecting members are illustrated in this embodiment, the number of projecting members can be more or less than 12 without exceeding the scope of this invention. Likewise, while the projecting members are shown as being linear and having a generally constant width along their lengths, the projecting members could be curved and/or have varying widths without exceeding the scope of this invention. The spacers of this embodiment and the other embodiments may be made from graphite, carbon-carbon composites, carbon-ceramic composites, steel, aluminum alloy, or any other convenient material suitable for use in a CVD furnace.

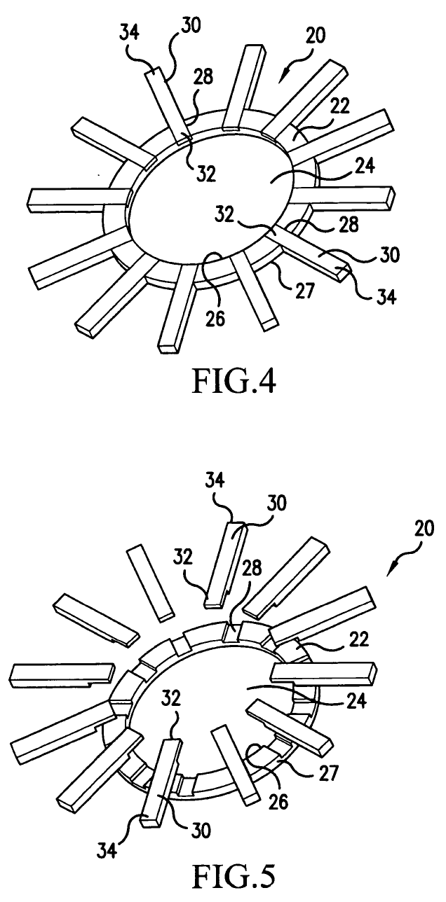

A variation of the first embodiment is illustrated in FIGS. 4 and 5 in which a spacer having separate hub and finger elements is disclosed. Spacer 20 comprises a hub 22 having an open center 24 having a periphery 26 and an outer hub periphery 27. A plurality of notches 28 are formed in the hub 22 each for receiving one of a plurality of fingers 30 having proximal ends 32 and distal ends 34. Proximal ends 32 are secured in notches 28 using suitable adhesives or connectors (not shown) or by forming proximal ends 32 and notches 28 in a tongue-and-groove manner so that the proximal ends slide or snap into notches 28 to retain the fingers 30.

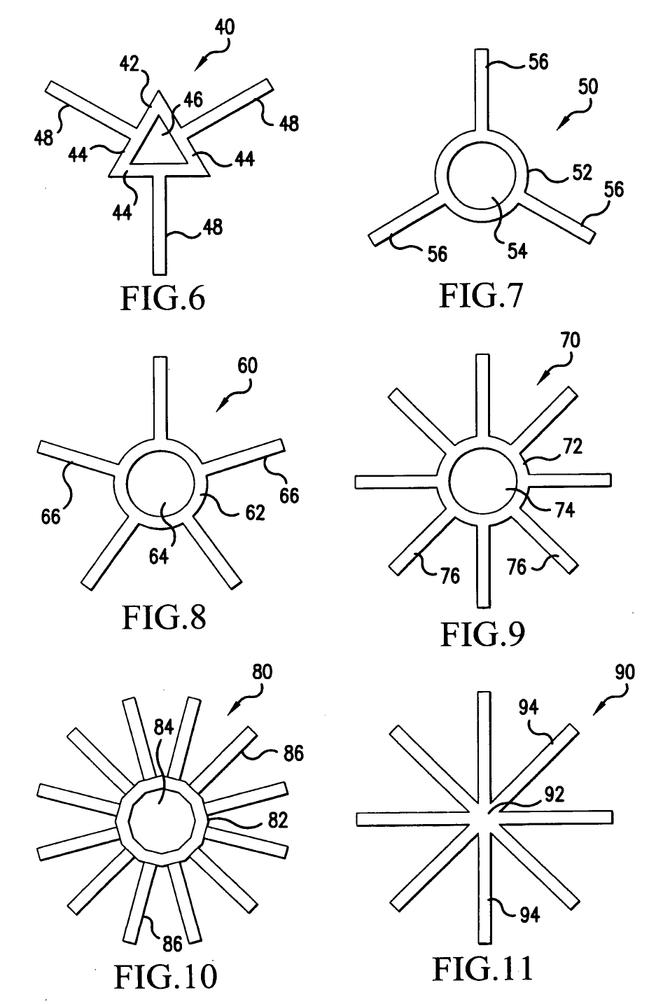

A second embodiment of the present invention is illustrated in FIG. 6 in which a spacer 40 is illustrated that includes a polygonal hub 42, which in this instance has three sides 44, and an open center 46. Three members 48 project from hub 42. Polygonal hubs having different numbers of sides can also be used, and the number of projecting members 48 does not necessarily have to be equal to the number of sides of the polygonal hub.

A third embodiment of the present invention is illustrated in FIG. 7 which comprises a spacer 50 having a circular hub 52 and an open center 54. Three members 56 project radially from hub 52.

A fourth embodiment of the present invention is illustrated in FIG. 8 which comprises a spacer 60 having a circular hub 62 and an open center 64. Five members 66 project radially from hub 52. In the third and fourth embodiments, the longitudinal centerlines of each of the members 66 do not intersect the centerlines of the other members 66.

A fifth embodiment of the present invention is illustrated in FIG. 9 which comprises a spacer 70 having a circular hub 72 and an open center 74. Eight members 76 project radially from hub 72. In this embodiment, oppositely disposed pairs of the members 76 share longitudinal centerlines.

A sixth embodiment of the present invention is illustrated in FIG. 10 which comprises a spacer 80 having a twelve-sided hub 82 and an open center 84. Twelve members 86 project normally from each of the sides of hub 82.

A seventh embodiment of the present invention is illustrated in FIG. 11 which comprises a spacer 90 having a solid central hub 92 from which eight fingers 94 project.

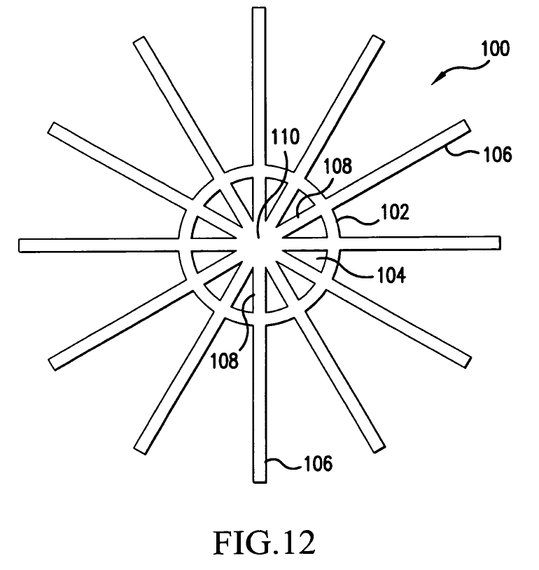

An eighth embodiment of the present invention is illustrated in FIG. 12 which comprises a spacer 100 having a circular outer hub 102 having an open center 104. A plurality of members 106 project radially outwardly from outer hub 102. The members 106 also include extensions 108 projecting inwardly to form a solid inner hub 110.

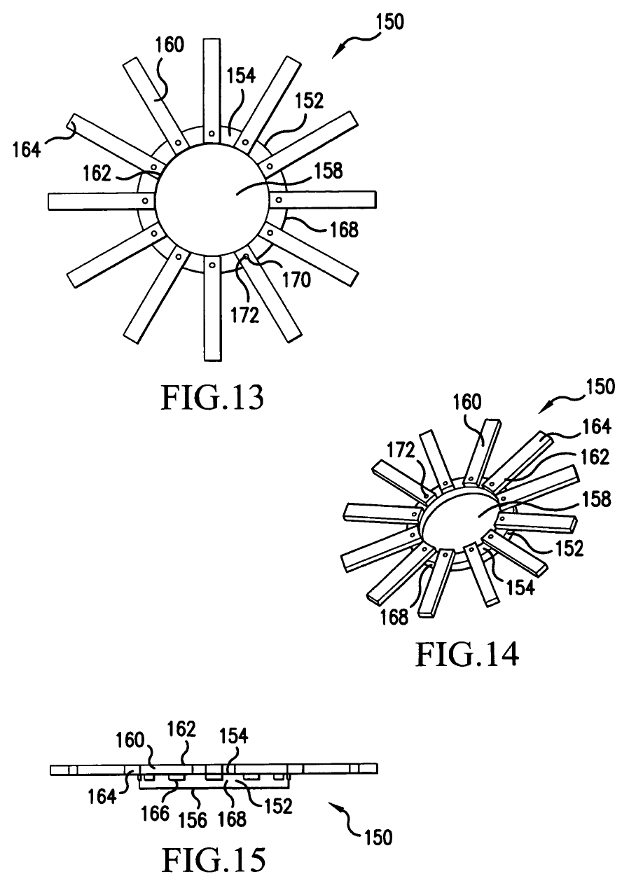

A ninth embodiment of the invention is illustrated in FIGS. 13-15 wherein a spacer 150 comprising a hub 152 having a top 154, a bottom 156, an open center 158 with a width and an outer periphery is illustrated. A plurality of members or fingers 160 having proximal ends 162 and distal ends 164 are connected to top 154 of hub 152 so that members 160 extend radially from the hub 152. A flap 166, illustrated in FIG. 15, is provided near the proximal end 162 of each member which abuts the outer peripheral wall of the 168 of hub 152 to position members 160 and provide additional surface area that is useful, for example, when an adhesive is used to connect the members 160 to the hub 152. The proximal ends 162 of the members 160 are provided with bores 170 aligned with bores (not shown) in hub 152 for receiving pins 172. A combination of pins 172 and adhesive has been found to effective for securing members 160 to hub 152; however, as with the previous embodiments, spacer 150 can be formed from a unitary block of material, or the members 160 can be connected to hub 152 in various other ways. It is presently believed that offsetting members 160 from hub 152 in this manner may provide for improved airflow around preforms when spacer 150 is used to space a plurality of preforms in a stack.

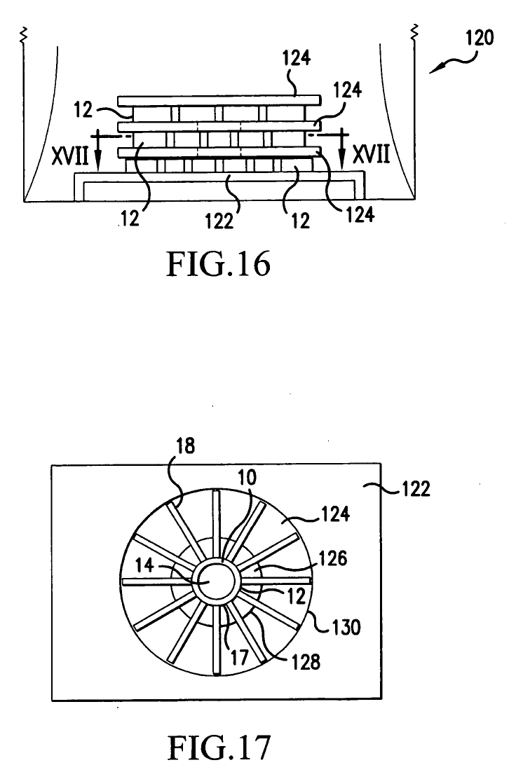

FIGS. 16 and 17 illustrate a furnace 120 comprising a floor or support 122 on which a spacer 10 according to the first embodiment of the invention and having a hub 12 is placed. A first annular preform 124 having an open central portion 126 having an open central portion periphery 128 and an outer periphery 130 is placed on top of spacer 12. A second spacer 12 is placed on the top of first annular preform 124 and additional annular preforms 124 and spacers 12 are stacked in a similar manner. Outer periphery 17 of hub 12 is generally sized to be smaller than the open central portion periphery 128 of the annular preforms 124 to allow for the free flow of gasses through the open central portions 126 of annular preforms 124 during processing, while the spaces between projecting members 18 allow for gas flow laterally through the stack. The unitary nature of the spacers 12 makes them relatively easy to move and position, and the open or generally open center portions permit relatively free movement of gas.

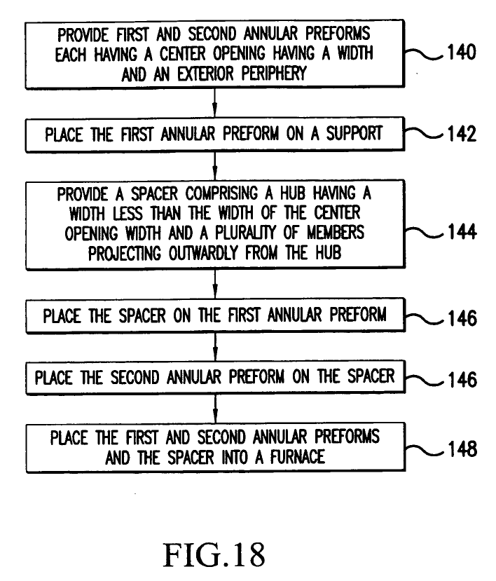

A method of spacing preforms according to an embodiment of the invention is illustrated in FIG. 18 and includes a step 140 of providing first and second annular preforms each having a center opening having a width and an exterior periphery and a step 142 of placing the first annular preform on a support. In addition, a spacer comprising a hub having a width less than the width of the center opening width and a plurality of members projecting outwardly from the hub is provided at a step 144, and the spacer is placed on the first preform at a step 145. The second annular preform is placed on the spacer in a step 146. The first and second annular preforms and spacer are placed in a furnace at a step 148.

The present invention has been described herein in terms of several preferred embodiments. Various modifications and additions to these embodiments will become apparent to those skilled in the relevant arts upon a reading of the foregoing description. It is intended that all such obvious modifications comprise a part of this invention to the extent that they are included within the scope of the several claims appended hereto.

We claim:

1. A furnace spacer for spacing a first annular preform from a second annular preform, each of the first and second annular preforms having an outer periphery and a width and an inner opening having a periphery and a width, said spacer comprising a hub having a width less than the inner opening width and a plurality of members projecting from said hub.

2. The furnace spacer of claim 1 wherein said hub comprises a closed curve or a regular polygon.

3. The furnace spacer of claim 1 wherein said hub has an open interior.

4. The furnace spacer of claim 1 wherein said plurality of members have equal lengths and are evenly spaced around said hub.

5. The furnace spacer of claim 1 wherein said plurality of members comprises a plurality of linear fingers having uniform widths.

6. The furnace spacer of claim 3 wherein said plurality of members include an extension projecting into said open interior.

7. The furnace spacer of claim 1 wherein said plurality of members are detachably connected to said hub.

8. The furnace spacer of claim 1 wherein said plurality of members are integrally formed with said hub.

9. The furnace spacer of claim 1 wherein said hub and said plurality of members are formed form a carbon-carbon composite.

10. The furnace spacer of claim 1 wherein said hub includes a first annular surface lying in a first plane and a second annular surface lying in a second plane spaced from said first plane, and wherein at least one of said plurality of members includes a surface lying in a third plane spaced from said first and second planes.

11. The furnace spacer of claim 1 wherein said hub includes a top and a bottom and wherein a portion of at least one of said plurality of members overlies said top.

12. A stack comprising a plurality of preforms and spacers stacked for treatment in a furnace,
each preform comprising a disk having a center opening having a width and having an outer periphery; and
each spacer comprising a hub having a width less than said center opening width and a plurality of members projecting outwardly from said hub;
wherein one of the plurality of spacers is provided between an adjacent pair of said plurality of preforms.

13. The stack of claim 12 wherein said plurality of members project radially from said hub.

14. The stack of claim 12 wherein said hub comprises an open interior.

15. The stack of claim 12 wherein said plurality of members each include an end distal from said hub and a greatest distance between distal ends of the plurality of members is less than a width of the outer periphery.

16. The stack of claim 12 wherein said spacers are formed from a carbon-carbon composite.

17. A method of spacing a first preform from a second preform in a furnace comprising the steps of:
providing first and second annular preforms each having a center opening having a width and an exterior periphery;
placing the first annular preform on a support;
providing a spacer comprising a hub having a width less than the width of the center opening width and a plurality of members projecting outwardly from said hub;
placing the spacer on the first annular preform;
placing the second annular preform on the spacer; and
placing the first and second annular preforms and the spacer into a furnace.

18. The method of claim 17 including the additional steps of:
providing a second spacer comprising a hub having a width less than the width of the center opening width and a plurality of projecting members projecting outwardly from the hub;
providing a third annular preform having a center opening having a width and an exterior periphery;
placing the second spacer on the second annular preform; and
placing the third annular preform on the second spacer.

19. The method of claim 18 including the additional step of aligning the projecting members of the first spacer with the projecting members of the second spacer.

20. The method of claim 18 including the additional steps of removing the first, second and third annular preforms from the furnace and separating the preforms from the spacers.
